(19) United States
(12) Patent Application Publication
(10) Pub. No.: US 2025/0030003 A1
(43) Pub. Date: Jan. 23, 2025

(54) Lithium-Metal Negative Electrodes with Base and Protection Layers

(71) Applicant: Cuberg, Inc., San Leandro, CA (US)

(72) Inventors: David Jorgensen, Mountain View, CA (US); Justin Skaggs, Oakland, CA (US); Andrea Chen, San Leandro, CA (US); Oluwamayowa Adigun, Santa Clara, CA (US); Gözde Barim, Berkeley, CA (US); Michelle Chen, Berkeley, CA (US); Sanjay Nanda, San Francisco, CA (US)

(73) Assignee: Cuberg, Inc., San Leandro, CA (US)

(21) Appl. No.: 18/780,161

(22) Filed: Jul. 22, 2024

Related U.S. Application Data
(60) Provisional application No. 63/515,066, filed on Jul. 21, 2023.

(51) Int. Cl. H01M 4/62; H01M 4/02; H01M 4/134; H01M 4/36; H01M 4/38

(52) U.S. Cl. CPC H01M 4/628; H01M 4/134; H01M 4/366; H01M 4/382; H01M 2004/021; H01M 2004/027

(57) ABSTRACT

Described herein are lithium-metal negative electrodes, lithium-metal liquid-electrolyte electrochemical cells comprising such electrodes, and methods of fabricating such electrodes. In some examples, a lithium-metal negative electrode comprises a base layer comprising aluminum and/or titanium. The lithium-metal negative electrode also comprises a protection layer disposed on and supported by the base layer and comprising copper, silicon, zinc, magnesium, nickel, molybdenum, tungsten, tantalum, and/or silver. Furthermore, the lithium-metal negative electrode comprises a lithium-metal negative active material layer attached to and supported by the protection layer such that the protection layer is positioned between the negative-electrode base layer and the lithium-metal negative active material layer. In some examples, the lithium-metal negative electrode further comprises an additional protection layer disposed on and supported by the negative-electrode base layer such that the base layer is positioned between the protection layer and the additional protection layer.

### CROSS-REFERENCE TO RELATED APPLICATIONS

This application claims the benefit under 35 U.S.C. § 119 (e) of U.S. Provisional Patent Application 63/515,066 (Docket No. CUBRP124P_20239016-US1) by David Jorgensen, entitled: “Lithium-Metal Negative Electrodes with Base and Protection Layers”, filed on 2023 Jul. 21, which is incorporated herein by reference in its entirety for all purposes.

### BACKGROUND

Lithium-ion (Li-ion or Lil) cells or, more generally, Li-ion batteries are widely used for various applications. For example, Li-ion batteries are used to power devices as small as medical devices or cell phones and as large as electric vehicles or aircraft. The wide adoption of Li-ion batteries across many industries generated many useful designs and knowledge about fabricating Li-ion battery modules and packs. In particular, many concerns involving cycling efficiency, capacity, and safety have been addressed in Li-ion batteries.

Lithium metal (Li-metal or LiM) cells represent a different battery type and are distinct from Li-ion cells. Specifically, Li-ion cells utilize special negative-electrode active materials (e.g., graphite, silicon) to trap lithium ions when the Li-ion cells are charging. On the other hand, Li-metal cells utilize the direct deposition (e.g., plating) of lithium metal on the negative current collectors without a need for any additional active materials for trapping lithium ions. As such, Li-metal cells tend to have a lower weight and a higher energy density in comparison to Li-ion cells. For example, Li-metal has a specific capacity of 3,860 mAh/g, which is about ten times higher than that of graphite.

However, Li-metal cells or, more generally, Li-metal batteries are currently not widely adopted at the scale of Li-ion batteries. One limitation involves Li-metal-containing negative electrodes, which can be difficult to manufacture, handle, and operate in Li-metal batteries. For example, Li-metal can be used as standalone structures (e.g., as thick lithium foils) or as layers formed on another substrate. It should be noted that Li-metal has very weak mechanical properties in comparison to other metals. For example, Li-metal tensile strength is only 1.5 MPa, copper's tensile strength is 210 MPa, and aluminum's tensile strength is up to 600 MPa (in the alloy form). Even polymers have tensile strengths that are greater than that of Li-metal, e.g., polypropylene (PP) has a tensile strength of 30-40 MPa, while high-density polyethylene (HDPE) has a tensile strength of 25-30 MPa.

When Li-metal is provided in a layer formed on another substrate, the mechanical, weight, electrical, and electrochemical properties of this substrate determine the properties of the Li-metal-containing negative electrode and that of the resulting Li-metal battery. For example, a stronger substrate is desired to ensure that the Li-metal-containing negative electrode can be easily handled. Typically, metals are stronger than polymers. A lighter substrate (with a lower density) is desired to improve the gravimetric capacity of the Li-metal battery. A conductive substrate is desired to ensure electron transport during the charge and discharge of the Li-metal battery (i.e., plating and de-plating of lithium metal on the Li-metal-containing negative electrode). Most metals are conductive, while typical polymers are not conductive. Finally, the electrochemical potential of the Li-metal-containing negative electrode typically limits the type of metals that can come in contact with the electrolyte on the negative electrode. Specifically, the negative electrode can operate at a low potential (e.g., 0.5 to 2.5 V vs. Li/Li⁺) and some metals are unstable at this potential. For example, aluminum has a negative redox potential of −1.662V, while titanium has a redox potential of −0.163. As such, aluminum and, to some extent, titanium can oxidize at the low potentials of the negative electrode (while remaining stable at the high potentials of the positive electrode). For comparison, copper has a redox potential of +0.342V.

What is needed are electrode structures that allow using new metals as base layers in Li-metal-containing negative electrodes.

### SUMMARY

Described herein are lithium-metal negative electrodes, lithium-metal liquid-electrolyte electrochemical cells comprising such electrodes, and methods of fabricating such electrodes. In some examples, a lithium-metal negative electrode comprises a base layer comprising aluminum and/or titanium. The lithium-metal negative electrode also comprises a protection layer disposed on and supported by the base layer and comprising copper, silicon, zinc, magnesium, nickel, molybdenum, tungsten, tantalum, and/or silver. Furthermore, the lithium-metal negative electrode comprises a lithium-metal negative active material layer attached to and supported by the protection layer such that the protection layer is positioned between the negative-electrode base layer and the lithium-metal negative active material layer. In some examples, the lithium-metal negative electrode further comprises an additional protection layer disposed on and supported by the negative-electrode base layer such that the base layer is positioned between the protection layer and the additional protection layer.

Clause 1. A lithium-metal negative electrode comprising: a negative-electrode base layer comprising a base-layer metal selected from the group consisting of aluminum and titanium; a protection layer disposed on and supported by the negative-electrode base layer and comprising a protection-layer material selected from the group consisting of copper, silicon, zinc, magnesium, nickel, tungsten, molybdenum, tantalum, and silver; and a lithium-metal negative active material layer attached to and supported by the protection layer such that the protection layer is positioned between the negative-electrode base layer and the lithium-metal negative active material layer.

Clause 2. The lithium-metal negative electrode of clause 1, wherein the negative-electrode base layer has a thickness of between 4 micrometers and 10 micrometers.

Clause 3. The lithium-metal negative electrode of clause 1, wherein the negative-electrode base layer is a metal foil.

Clause 4. The lithium-metal negative electrode of clause 1, wherein the base-layer metal is aluminum.

Clause 5. The lithium-metal negative electrode of clause 1, wherein the base-layer metal is titanium.

Clause 6. The lithium-metal negative electrode of clause 1, wherein the protection-layer material is copper.

Clause 7. The lithium-metal negative electrode of clause 1, wherein the protection-layer material is zinc.

Clause 8. The lithium-metal negative electrode of clause 1, wherein: the base-layer metal is aluminum, and the protection-layer material is copper.

Clause 9. The lithium-metal negative electrode of clause 1, wherein the protection layer has a thickness of between 25 nanometers and 100 nanometers.

Clause 10. The lithium-metal negative electrode of clause 1, further comprising an additional protection layer disposed on and supported by the negative-electrode base layer and comprising the protection-layer material such that the negative-electrode base layer is positioned between the protection layer and the additional protection layer.

Clause 11. The lithium-metal negative electrode of clause 10, further comprising an additional lithium-metal negative active material layer attached to and supported by the additional protection layer such that the additional protection layer is positioned between the negative-electrode base layer and the additional lithium-metal negative active material layer.

Clause 12. The lithium-metal negative electrode of clause 10, wherein a combination of the negative-electrode base layer, the protection layer, and the additional protection layer has a weight-per-unit-area ratio of less than 26 g/m2.

Clause 13. The lithium-metal negative electrode of clause 10, wherein a combination of the negative-electrode base layer, the protection layer, and the additional protection layer has a weight-per-unit-area ratio of less than 23 g/m2.

Clause 14. The lithium-metal negative electrode of clause 10, wherein a combination of the negative-electrode base layer, the protection layer, and the additional protection layer has a weight-per-unit-area ratio of less than 20 g/m2.

Clause 15. The lithium-metal negative electrode of clause 10, wherein a combination of the negative-electrode base layer, the protection layer, and the additional protection layer has a sheet resistance of less than 10 mOhm/sq.

Clause 16. The lithium-metal negative electrode of clause 10, wherein a combination of the negative-electrode base layer, the protection layer, and the additional protection layer has an elastic modulus of at least 50 GPa.

Clause 17. The lithium-metal negative electrode of clause 1, wherein the lithium-metal negative active material layer has a thickness of less than 20 micrometers.

Clause 18. A lithium-metal liquid-electrolyte electrochemical cell comprising: a lithium-metal negative electrode comprising a negative-electrode base layer, a protection layer, and a lithium-metal negative active material layer, wherein: the negative-electrode base layer comprises a base-layer metal selected from the group consisting of aluminum and titanium, the protection layer is disposed on and supported by the negative-electrode base layer and comprises a protection-layer material selected from the group consisting of copper, silicon, zinc, magnesium, nickel, and silver, and the lithium-metal negative active material layer is attached to and supported by the protection layer such that the protection layer is positioned between the negative-electrode base layer and the lithium-metal negative active material layer; a positive electrode; a separator, positioned between the lithium-metal negative electrode and positive electrode; and liquid electrolyte, soaking the separator, the positive electrode, and the lithium-metal negative electrode, and providing ionic conductivity between the lithium-metal negative electrode and positive electrode.

Clause 19. The lithium-metal liquid-electrolyte electrochemical cell of clause 18, wherein the base-layer metal is titanium.

Clause 20. The lithium-metal liquid-electrolyte electrochemical cell of clause 18, wherein the protection-layer material is zinc.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, and methods for continuous deposition of electrochemically active metals using thermal evaporation. These drawings in no way limit any changes in form and detail that may be made by one skilled in the art without departing from the spirit and scope of the disclosed implementations.

FIG. 1 is a schematic block diagram of a lithium-metal liquid-electrolyte electrochemical cell comprising a lithium-metal negative electrode with a base layer and one or more protection layers, in accordance with some examples.

FIG. 2 is a schematic cross-sectional view of a lithium-metal negative electrode comprising a base layer positioned between two protection layers as well as lithium-metal negative active material layers, in accordance with some examples.

FIG. 3 is a process flowchart corresponding to a method for fabricating a lithium-metal negative electrode in FIG. 2, in accordance with some examples.

FIG. 4 is a block diagram of an electric vehicle (e.g., aircraft) comprising a battery pack, which in turn comprises one or more lithium-metal liquid-electrolyte electrochemical cells, in accordance with some examples.

### DETAILED DESCRIPTION

### Introduction

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

Current collectors serve two functions in battery cells, such as lithium-ion batteries (LIBs) and lithium-metal batteries (LMBs). One of these functions is to conduct the electric current between the active material layers (e.g., lithium-metal layers in LMBs) and cell tabs during the charge and discharge. The other function is to mechanically support the active material layers. For example, handling a standalone lithium-metal layer during the fabrication of LMBs is challenging when the thickness of this layer is less than 10-20 micrometers. At the same time, current collectors need to operate in contact with the electrolyte at the potentials of the respective electrodes.

Referring to negative electrodes in LMBs, a copper foil or a metallized polymer can be used as current collectors. Copper has excellent electronic conductivity (58×10⁶ S/m), but it is heavy (8.96 g/cm³). For comparison, aluminum's conductivity is 38×10⁶ S/m, while aluminum's density is 2.7 g/cm³. As such, the conductivity-to-density ratio is twice better for aluminum than for copper. However, aluminum is not electrochemically compatible with negative electrodes when directly exposed to electrolytes at the potentials of typical to negative electrodes in LMBs. It should be noted that there are no issues with using aluminum for positive electrodes since the potentials are different. Furthermore, aluminum will react with lithium when interfacing with lithium metal in LMBs. As an additional reference, titanium's conductivity is 7.61×10⁶ S/m, while titanium's density is 4.506 g/cm³. While polymers' density tends to be lower than that of aluminum, titanium, and copper, polymers are generally not conductive. As such, negative electrodes with current collectors formed from metalized polymers tend to have too high sheet resistance. Furthermore, metalized polymers are difficult to weld to and may not have adequate mechanical strength to maintain flatness during the cycling of LMBs.

Described herein are lithium-metal negative electrodes comprising base layers comprising aluminum and/or titanium. A base layer is covered with a protection layer which is disposed on and supported by the base layer and comprises copper, silicon, zinc, magnesium, nickel, molybdenum, tungsten, tantalum, and/or silver. For example, a base layer can have a thickness of 4-10 micrometers, while a protection layer has a thickness of 25-100 nanometers. As such, the base layer provides the most electronic conductivity and mechanical support in this current-collector structure. It should be also noted that aluminum and titanium are much lighter than copper. In some examples, the current collector basis weight, defined as a weight-per-unit-area ratio, is less than 26 g/m² or even less than 23 g/m² or even 20 g/m².

Since electronically conductive metals are used as a base layer (rather than non-conductive polymers as in metalized-polymer current collectors), the sheet resistance is much lower for the metal-on-metal current collectors vs. metalized-polymer current collectors. For example, a 9-micrometer thick aluminum foil coated with 50-nanometer thick copper layers (one copper layer on each side of the aluminum foil) has a sheet resistance of 2.9 mOhm/sq, an elastic modulus of 69 GPa, and a basis weight of 25 g/m². For comparison, a 6-micrometer thick polyethylene terephthalate (PET) film metalized with 1000-nanometer thick copper layers (one on each side) has a sheet resistance of 17.2 mOhm/sq (6 times higher), an elastic modulus of 35 GPa (2 times lower), and a basis weight of 26 g/m² (4% heavier).

A protection layer can be formed using various techniques such as magnetron sputtering physical vapor deposition (PVD), e-beam evaporation PVD, thermal evaporation PVD, high-power impulse magnetron sputtering (HIPIMS), electroplating, thermal plasma spray, suspension plasma spraying, and cold spraying.

Furthermore, the lithium-metal negative electrode comprises a lithium-metal negative active material layer attached to and supported by the protection layer such that the protection layer is positioned between the negative-electrode base layer and the lithium-metal negative active material layer. Because the base layer provides mechanical support and electronic conductivity, the thickness of the lithium-metal layer can be a lot less than in the example where a lithium-metal foil is used as a standalone structure. For example, the thickness of the lithium-metal layer can be less than 10 micrometers, less than 8 micrometers, or even less than 5 micrometers. In some (anode-less) examples, the lithium-metal negative electrode is initially free from any lithium metal. In these examples, the lithium metal is deposited over the protection layer during the initial charge of the battery.

### Examples of Lithium-Metal Liquid-Electrolyte Electrochemical Cells

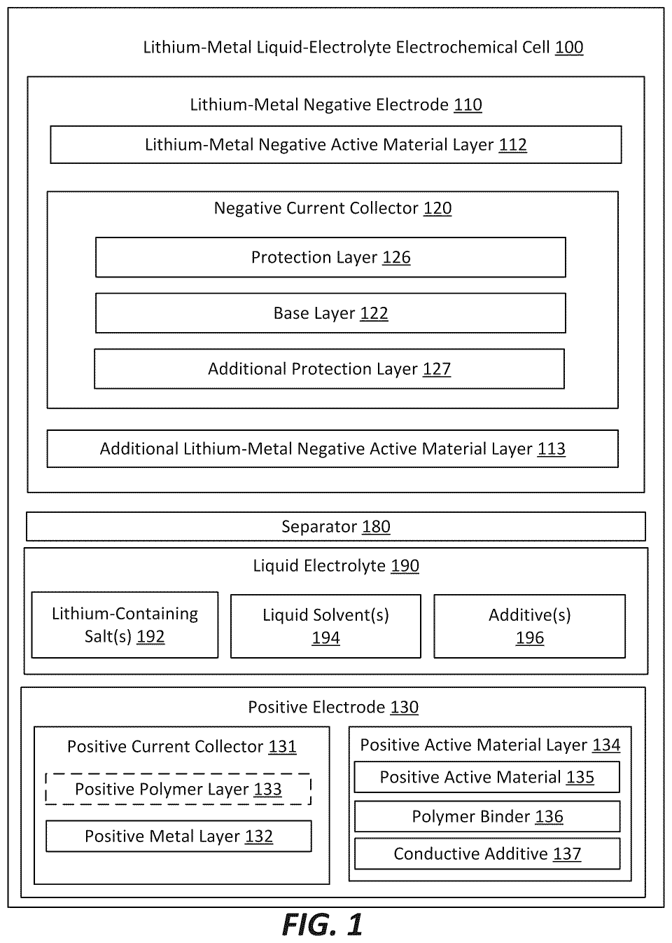

FIG. 1 is a schematic block diagram of lithium-metal liquid-electrolyte (LiMLE) electrochemical cell 100 comprising lithium-metal negative electrode 110 with base layer 122 and one or more protection layers (e.g., protection layer 126 and additional protection layer 127), in accordance with some examples. In addition to lithium-metal negative electrode 110, LiMLE electrochemical cell 100 comprises positive electrode 130 and separator 180, which is positioned between lithium-metal negative electrode 110 and positive electrode 130 and provides electronic isolation between lithium-metal negative electrode 110 and positive electrode 130. One having ordinary skill in the art would understand that LiMLE electrochemical cell 100 can have any number of positive and negative electrodes arranged in different ways, e.g., stacked, wound, and the like. LiMLE electrochemical cell 100 also comprises liquid electrolyte 190, which provides ionic transfer between lithium-metal negative electrode 110 and positive electrode 130. For example, liquid electrolyte 190 soaks separator 180 or, more specifically, the pores of separator 180. Liquid electrolyte 190 should be distinguished from solid and gel electrolytes used in other types of lithium-metal cells. Liquid electrolyte 190 should be distinguished from gel electrolytes, in which polymer matrices are used to retain salts and solvents. Liquid electrolyte 190 described herein are free from polymer components such as polyacrylonitrile (PAN), polymethylmethacrylate (PMMA), polyvinylchloride (PVC), and polyvinylidene fluoride (PVDF) and have a viscosity of less than 1,000 cP, less than 500 cP, or less than 200 cP at the room temperature.

Some examples of liquid electrolyte 190 include, but are not limited to, a mixture of one or more lithium-containing salts 192 and one or more liquid solvents 194. Some examples of lithium-containing salts 192 include, but are not limited to, lithium bis(fluorosulfonyl)imide (LiFSI), lithium bis(trifluoromethylsulfonyl)amide (LiTFSI), lithium tetrafluoroborate (LiBF₄), lithium hexafluorophosphate (LiPF₆), lithium bis(oxalato) borate (LiBOB), lithium difluoro (oxalato) borate (LiDFOB), lithium trifluoromethanesulfonate (LiTf), lithium nitrate (LiNO₃), and various combinations thereof. In some examples, lithium-containing salts 192 are LiFSI or LiTFSI, e.g., preferably LiFSI. Lithium-containing salts 192 are configured to dissociate into lithium ions and anions. In some examples, the concentration of lithium-containing salts 192 in liquid electrolyte 190 is between 10 mol % and 50 mol % or, more specifically, between 20 mol % and 40 mol %.

Some examples of liquid solvents 194 but are not limited to, one or more cyclic ethers (e.g., 1,3-dioxane (DOL), 1,4-dioxane (DX), tetrahydrofuran (THF)), one or more linear ethers (e.g., dimethoxyethane (DME), Bis(2-methoxyethyl) ether (G2), triethylene glycol dimethyl ether (G3), or tetraethylene glycol dimethyl ether (G4), Bis(2,2,2-trifluoroethyl) ether (BTFE), ethylal, 1,1,2,2-tetrafluoroethyl 2,2,3,3-tetrafluoropropyl ether (TFPE)), and a combination thereof. In some examples, the concentration of liquid solvents 194 in liquid electrolyte 190 is between 0 mol % and 60 mol % or, more specifically, between 5 mol % and 50 mol % or even between 10 mol % and 40 mol %. A specific category of liquid solvents 194 is fluoroether diluents, e.g., bis(2,2,2-trifluoroethyl) ether (BTFE), ethylal, and 1,1,2,2-tetrafluoroethyl 2,2,3,3-tetrafluoropropyl ether (TFPE)), 0-60 mol %. More molecules could be added here.

Liquid electrolyte 190 can comprises various additives 196, e.g., metal salts (e.g., having bis(trifluoromethanesulfonyl)imide (TFSI), bis(fluorosulfonyl)imide (FSI), hexafluorophosphate (PF₆), tetrafluoroborate (BF₄), and/or bis(oxalate) borate (BOB) anions), ionic liquids (e.g., propyl-methyl-pyrrolidinium-FSI/TFSI; butyl-methyl-pyrrolidinium-FSI/TFSI; octyl-methyl-pyrrolidinium-FSI/TFSI, and any combination thereof), and the like.

In some examples, liquid electrolyte 190 comprises ionic liquids in addition to or instead of additives 196. Some examples of ionic liquids include, but are not limited to, 1-allyl-3-methylimidazolium bis(trifluoromethanesulfonyl)imide (AMIm) TFSI and 1-methyl-3-propylimidazolium bis(trifluoromethanesulfonyl)imide (Im₁₃TFSI, or Im₁₃TFSI—SiO₂), n-methyl-n-propylpiperidinium bis(trifluoromethanesulfonyl)imide (Pip₁₃TFSI or Pip₁₃TFSI—SiO₂), n-propyl-n-methylpyrrolidinium bis(fluoromethanesulfonyl)imide (PYR₁₃FSI), n-butyl-n-methylpyrrolidinium bis(fluorosulfonyl)imide (PYR₁₄FSI), tri-methylhexyl ammonium bis-(trifluorosulfonyl)imide (TMHATFSI), butyl-trimethyl ammonium bis(trifluoromethanesulfonyl)imide (QATFSI), 3-(2-(2-methoxy ethoxy)ethyl)-1-methylimidazolium TFSI (IMI_{1,10201}TFSI) and 1-(2-methoxyethyl)-3-methylimidazolium TFSI (IMI_{1,201}TFSI). In some examples, the concentration of the ionic liquids in liquid electrolyte 190 is between 0 mol % and 40 mol % or, more specifically, between 5 mol % and 35 mol %, or even between 10 mol % and 30 mol %.

In some examples, liquid electrolyte 190 can have a viscosity of at least 15 cP or, more specifically, at least 25 cP, at least 50 cP, or even at least 100 cP at room temperature. For example, liquid electrolyte 190 can have a viscosity of 15-500 cP or, more specifically, 20-300 cP or, more specifically, 40-200 cP at room temperature. High viscosity can be driven by specific components needed in liquid electrolyte 190 to enable the functioning of liquid electrolyte 190 in LiMLE electrochemical cell 100. It should be noted that the viscosity changes with temperature. In fact, this characteristic is used to enable the controlled deposition of lithium metal during fast charging (e.g., a charge rate of at least 0.8 C or even at least 1 C). The viscosity determined the ionic diffusivity (lithium ions) within liquid electrolyte 190. In some examples, liquid electrolyte 190 can have an ionic diffusivity of between 1E-13 m²/sec-1E-10 m²/sec or, more specifically, 5E-12 m²/sec-5E-10 m²/sec or, even more specifically, 1E-12 m²/sec-1E-11 m²/sec at room temperature.

Positive electrode 130 can include positive current collector 131 and positive active material layer 134. Positive current collector 131 comprises at least a metal layer 132, which may be a standalone layer (e.g., an aluminum foil). Alternatively, positive current collector 131 comprises one or more metal layers 132 supported on positive polymer layer 133 (e.g., an aluminum-metalized polymer). Positive active material layer 134 comprises positive active material 135 (e.g., in the form of particles) and binder 136 (e.g., a polymer binder). Some examples of positive active materials 135 include, but are not limited to, lithium nickel manganese cobalt (NMC) oxides, lithium iron phosphate, and the like. Some examples of suitable polymer binders 136 include, but are not limited to, polymer binders (e.g., polyvinylidene-fluoride (PVDF), styrene-butadiene rubber (SBR), and carboxyl methyl cellulose (CMC)). In some examples, positive electrode 130 comprises conductive additive 137 (e.g., carbon black/paracrystalline carbon).

In some examples, positive electrode 130 single-crystal nickel-manganese-cobalt (NMC)-containing structures, used as positive active material 135. The single-crystal NMC-containing structures can have a nickel concentration of at least 70% atomic or even at least 80% atomic. Because the bonds within the primary particles are stronger than between primary particles (in polycrystalline materials), single-crystal NMC particles inherently do not have or show intergranular cracking in a way that polycrystalline NMC particles do. Furthermore, single-crystal NMC particles tend to have higher specific capacities due to the greater surface-area-to-volume ratio of the individual particles vs. secondary-particle agglomerates of polycrystalline NMC materials. However, single-crystal NMC particles tend to have slower lithium transport kinetics than polycrystalline materials. As such, increased temperatures during the charge portion of the cycle help with increasing the rate of lithium-ion extraction from single-crystal NMC particles.

In some examples, single-crystal NMC particles are used with liquid electrolyte 190 comprising one or more imide-containing salts, such as bis(trifluoromethanesulfonyl)imide (TFSI⁻)-containing salts, bis(fluorosulfonyl)imide (FSI⁻)-containing salts, and bis(pentafluoroethanesulfonyl)imide (BETI⁻)-containing salts. These salts can also include various cations, such as lithium (Li⁺), potassium (K⁺), sodium (Na⁺), cesium (Cs⁺), n-propyl-n-methylpyrrolidinium (Pyr13+), n-octyl-n-methylpyrrolidinium (Pyr18⁺), and 1-methyl-1-pentylpyrrolidinium (Pyr15⁺). For example, imide-containing salts can act as a source of lithium ions in lithium-metal salts. In some examples, the liquid electrolyte further comprises one or more of 2,2,2-Trifluoroethyl Ether (TFEE), 1,1,2,2-Tetrafluoroethyl 2,2,3,3-tetrafluoropropyl ether (TFPE), one or more phosphites, and one or more phosphates.

Positive electrode 130, lithium-metal negative electrode 110, separator 180, and liquid electrolyte 190 can be referred to as internal components of lithium-metal electrochemical cell 100. These internal components are sensitive to moisture and other ambient conditions and insulated from the environment by a cell enclosure, such as a metal (e.g., aluminum) case (e.g., for cylindrical or prismatic cells), a pouch laminate, an aluminum-coated polymer (e.g., polyamide, polyester, polyurethane, and polypropylene). It should be noted that LiMLE electrochemical cell 100 can be heated internally and/or externally. When internal heating is used, the cell enclosure can be thermally insulated to reduce heat dissipation to the environment. Some examples of such thermally insulating features include, but are not limited to, different intercell structures (e.g., thermal-barrier sheet). It should be noted that such structures can also be used for applying cell pressure and/or preventing heat/material propagation during various thermal events. On the other hand, when external heating is used, the cell enclosure can be thermally conductive to promote heat transfer from an externally positioned heater to the cell interior. Some examples of such thermally conductive features include, but are not limited to, intercell heat-conducting structures (e.g., also used for cell cooling during other operations).

### Examples of Lithium-Metal Negative Electrodes

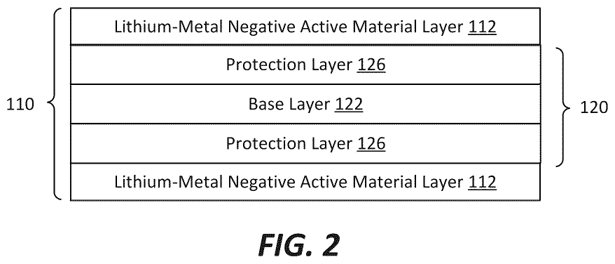

FIG. 2 is a schematic cross-sectional view of lithium-metal negative electrode 110 comprising base layer 122 positioned between two protection layers 126 as well as lithium-metal negative active material layers 122, in accordance with some examples. A combination of base layer 122 and any number of protection layers 126 (present in lithium-metal negative electrode 110) can be referred to as negative current collector 120. While FIG. 2 illustrates negative current collector 120 supporting two lithium-metal negative active material layers 112, in some examples, lithium-metal negative electrode 110 can include negative current collector 120 without any lithium-metal negative active material layers 112 (at least when lithium-metal negative electrode 110 is provided for fabrication of LiMLE electrochemical cell 100). These examples may be referred to as an anode-less design of lithium-metal negative electrode 110. When LiMLE electrochemical cell 100 is initially charged, lithium-metal negative active material layers 112 are formed (plated) over protection layers 126.

In some examples, negative-electrode base layer 122 comprises a base-layer metal selected from the group consisting of aluminum and titanium. For example, negative-electrode base layer 122 may comprise aluminum but not titanium (e.g., consists essentially of aluminum). In another example, negative-electrode base layer 122 may comprise titanium but not aluminum (e.g., consists essentially of titanium). In further examples, negative-electrode base layer 122 may comprise both titanium and aluminum (e.g., consists essentially of titanium). For purposes of this disclosure, the term “consists essentially of” is defined as a having composition of at least 95% atomic or even at least 99% atomic.

As noted above, aluminum has a better conductivity-to-weight ratio than copper, which can help to increase the gravimetric energy density. Furthermore, aluminum's tensile strength can be up to 600 MPa, while titanium's tensile strength can exceed 1,000 MPa (in some alloys). As such, both aluminum and titanium provide a strong mechanical base even when used as thin foils. In some examples, negative-electrode base layer 122 has a thickness of between 2 micrometers and 20 micrometers or, more specifically, 4 micrometers and 10 micrometers.

In the same or other examples, negative-electrode base layer 122 is a metal foil. However, other structures (e.g., mesh, foam) are within the scope.

In some examples, protection layer 126 is disposed on and supported by the negative-electrode base layer 122. Protection layer 126 comprises a protection-layer material selected from the group consisting of copper, silicon, zinc, magnesium, nickel, molybdenum, tungsten, tantalum, and silver. In some examples, the base-layer metal is aluminum, while the protection-layer material is copper. In some examples, protection layer 126 has a thickness of between 10 nanometers and 200 nanometers or, more specifically, between 25 nanometers and 100 nanometers.

When both sides of negative-electrode base layer 122 are exposed to liquid electrolyte 190, lithium-metal negative electrode 110 further comprises additional protection layer 127 disposed on and supported by negative-electrode base layer 122 and comprising the protection-layer material (e.g., the same materials as in protection layer 126). Specifically, negative-electrode base layer 122 is positioned between the protection layer 126 and the additional protection layer 127. Alternatively, the side of negative-electrode base layer 122, which faces away from protection layer 126, can be sealed from liquid electrolyte 190, and this side can be free from protection layers (e.g., exposed). For example, this side of negative-electrode base layer 122 can form an external surface of LiMLE electrochemical cell 100 and can be used to form a connection to LiMLE electrochemical cell 100.

In some examples, a combination of negative-electrode base layer 122, protection layer 126, and additional protection layer 127 has a weight-per-unit-area ratio of less than 26 g/m², less than 23 g/m², or even less than 20 g/m². In the same or other examples, wherein the combination of negative-electrode base layer 122, protection layer 126, and additional protection layer 127 has a sheet resistance of less than 20 mOhm/sq, less than 10 mOhm/sq, or even less than 5 mOhm/sq. Furthermore, the combination of negative-electrode base layer 122, protection layer 126, and additional protection layer 127 may have a elastic modulus of at least 30 GPa, at least 50 GPa, or even at least 100 GPa.

In some examples, lithium-metal negative active material layer 112 is attached to and supported by the protection layer 126. In these examples (e.g., shown in FIG. 2), protection layer 126 is positioned between the negative-electrode base layer 122 and the lithium-metal negative active material layer 112.

When lithium-metal negative electrode 110 comprises additional protection layer 127, lithium-metal negative electrode 110 can further comprise additional lithium-metal negative active material layer 113 attached to and supported by the additional protection layer 127. In these examples, additional protection layer 127 is positioned between negative-electrode base layer 122 and additional lithium-metal negative active material layer 113. This configuration may be referred to as a 2-sided electrode.

In some examples, lithium-metal negative active material layer 112 has a thickness of less than 40 micrometers, less than 20 micrometers, less than 10 micrometers, or even less than 5 micrometers. It should be noted that the addition of negative current collector 120 helps to keep the thickness of the lithium-metal layer small. For example, a thickness of less than 20 micrometers is difficult to achieve with freestanding lithium. As such, lithium-metal cells with negative electrodes formed by freestanding lithium foils/layers require substantially more lithium than lithium-metal cells with negative electrodes formed by a combination of a current collector and a lithium-metal layer (to achieve the same cell capacity). Lower amounts of lithium are highly desirable from the safety perspective as less lithium ejecta (e.g., molten lithium ejecta) needs to be contained when the cell goes into a thermal runaway. It should be noted that lithium-metal negative electrode 110 forms a solid electrolyte interphase (SEI) layer when exposed to liquid electrolyte 190 at operating potentials. Furthermore, a naturally-forming SEI layer can be supplemented with or partially/fully replaced with an artificial SEI layer (e.g., formed on the surface of lithium-metal negative electrode 110 before contacting liquid electrolyte 190). In either case, an SEI layer (natural and/or artificial) can interfere with the lithium-ion migration in and out of lithium-metal negative electrode 110. Raising the temperature before charging, helps to improve the ionic conductivity of such SEI layers.

### Methods for Fabricating Lithium-Metal Negative Electrodes

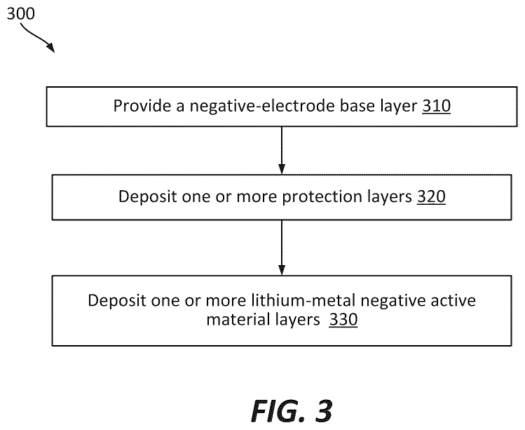

FIG. 3 is a process flowchart corresponding to method 300 for fabricating lithium-metal negative electrode 110 in FIG. 2, in accordance with some examples. In some examples, method 300 commences with (block 310) providing negative-electrode base layer 122, various examples of which are described above. Negative-electrode base layer 122 can be provided in a roll form.

Method 300 may proceed with (block 320) depositing one or more protection layers (e.g., protection layer 126 and additional protection layer 127). Various deposition techniques can be used for this operation, e.g., magnetron sputtering PVD, e-beam evaporation PVD, thermal evaporation PVD, HIPIMS, electroplating, thermal plasma spraying, suspension plasma spraying, and cold spraying. Various examples of protection layers are described above with reference to FIG. 2.

Method 300 may proceed with (block 330) depositing one or more lithium-metal negative active material layers (e.g., lithium-metal negative active material layer 112 and additional lithium-metal negative active material layer 113). Various deposition techniques can be used for this operation, e.g., thermal evaporation PVD.

### Application Examples

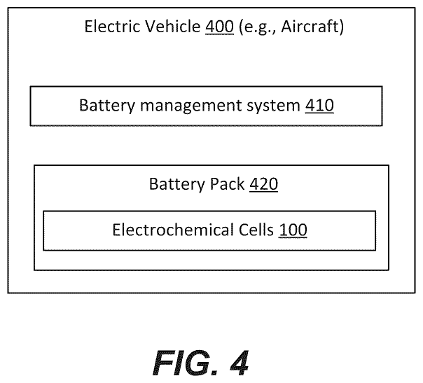

LiMLE electrochemical cell 100 described herein, can be used for various applications, such as ground-based vehicles, boats, aircraft, and spacecraft. For example, aircraft and/or spacecraft use Li-metal batteries as such batteries have significantly higher gravimetric energy density than, e.g., Li-ion batteries. Both aircraft and spacecraft applications require lower mass cells, as additional mass leads to lower payload capacity. For these applications to utilize the maximum amount of their designed capacity, the energy system must be the lowest mass possible. In addition, safety is paramount in both of these applications, as onboard fires while in flight could be mission-critical and cause catastrophic failure of the system. In this scenario, occupants or personnel using the system are not able to simply depart from aircraft and/or spacecraft (e.g., in comparison to ground-based vehicles). FIG. 4 is a block diagram of electric vehicle 400 (e.g., aircraft) comprising battery pack 420, which in turn comprises one or more LiMLE electrochemical cells 100. Electric vehicle 400 also comprises battery management system 410, electrically and communicatively coupled to battery pack 420.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A lithium-metal negative electrode comprising:
a negative-electrode base layer comprising a base-layer metal selected from the group consisting of aluminum and titanium;
a protection layer disposed on and supported by the negative-electrode base layer and comprising a protection-layer material selected from the group consisting of copper, silicon, zinc, magnesium, nickel, tungsten, molybdenum, tantalum, and silver; and
a lithium-metal negative active material layer attached to and supported by the protection layer such that the protection layer is positioned between the negative-electrode base layer and the lithium-metal negative active material layer.

2. The lithium-metal negative electrode of claim 1, wherein the negative-electrode base layer has a thickness of between 4 micrometers and 10 micrometers.

3. The lithium-metal negative electrode of claim 1, wherein the negative-electrode base layer is a metal foil.

4. The lithium-metal negative electrode of claim 1, wherein the base-layer metal is aluminum.

5. The lithium-metal negative electrode of claim 1, wherein the base-layer metal is titanium.

6. The lithium-metal negative electrode of claim 1, wherein the protection-layer material is copper.

7. The lithium-metal negative electrode of claim 1, wherein the protection-layer material is zinc.

8. The lithium-metal negative electrode of claim 1, wherein:
the base-layer metal is aluminum, and
the protection-layer material is copper.

9. The lithium-metal negative electrode of claim 1, wherein the protection layer has a thickness of between 25 nanometers and 100 nanometers.

10. The lithium-metal negative electrode of claim 1, further comprising an additional protection layer disposed on and supported by the negative-electrode base layer and comprising the protection-layer material such that the negative-electrode base layer is positioned between the protection layer and the additional protection layer.

11. The lithium-metal negative electrode of claim 10, further comprising an additional lithium-metal negative active material layer attached to and supported by the additional protection layer such that the additional protection layer is positioned between the negative-electrode base layer and the additional lithium-metal negative active material layer.

12. The lithium-metal negative electrode of claim 10, wherein a combination of the negative-electrode base layer, the protection layer, and the additional protection layer has a weight-per-unit-area ratio of less than 26 g/m².

13. The lithium-metal negative electrode of claim 10, wherein a combination of the negative-electrode base layer, the protection layer, and the additional protection layer has a weight-per-unit-area ratio of less than 23 g/m².

14. The lithium-metal negative electrode of claim 10, wherein a combination of the negative-electrode base layer, the protection layer, and the additional protection layer has a weight-per-unit-area ratio of less than 20 g/m².

15. The lithium-metal negative electrode of claim 10, wherein a combination of the negative-electrode base layer, the protection layer, and the additional protection layer has a sheet resistance of less than 10 mOhm/sq.

16. The lithium-metal negative electrode of claim 10, wherein a combination of the negative-electrode base layer, the protection layer, and the additional protection layer has an elastic modulus of at least 50 GPa.

17. The lithium-metal negative electrode of claim 1, wherein the lithium-metal negative active material layer has a thickness of less than 20 micrometers.

18. A lithium-metal liquid-electrolyte electrochemical cell comprising:
a lithium-metal negative electrode comprising a negative-electrode base layer, a protection layer, and a lithium-metal negative active material layer, wherein:
the negative-electrode base layer comprises a base-layer metal selected from the group consisting of aluminum and titanium,
the protection layer is disposed on and supported by the negative-electrode base layer and comprises a protection-layer material selected from the group consisting of copper, silicon, zinc, magnesium, nickel, and silver, and
the lithium-metal negative active material layer is attached to and supported by the protection layer such that the protection layer is positioned between the negative-electrode base layer and the lithium-metal negative active material layer;
a positive electrode;
a separator, positioned between the lithium-metal negative electrode and positive electrode; and
liquid electrolyte, soaking the separator, the positive electrode, and the lithium-metal negative electrode, and providing ionic conductivity between the lithium-metal negative electrode and positive electrode.

19. The lithium-metal liquid-electrolyte electrochemical cell of claim 18, wherein the base-layer metal is titanium.

20. The lithium-metal liquid-electrolyte electrochemical cell of claim 18, wherein the protection-layer material is zinc.
